(19) United States
(12) Patent Application Publication
(10) Pub. No.: US 2009/0145540 A1
(43) Pub. Date: Jun. 11, 2009

(54) Pharmacy labels including methods of making and using the same

(76) Inventor: Roger L. Francoeur, Omaha, NE (US)

Correspondence Address: K&L Gates LLP, STATE STREET FINANCIAL CENTER, One Lincoln Street, BOSTON, MA, 02111-2950, US

(21) Appl. No.: 12/001,212

(22) Filed: Dec. 10, 2007

(51) Int. Cl. B32B 9/00; B29C 65/00

(52) U.S. Cl. 156/249; 428/40.1

(57) ABSTRACT

The present teachings relate to labels and, more particularly, pharmacy labels. In one aspect, the present teachings relate to a label laminate that includes a label sheet having a main label and one or more auxiliary labels, the label sheet being releasably adhered to a release liner, where the main label and one or more auxiliary labels are removable from a first portion of the release liner while remaining releasably adhered to a second portion of a release liner, i.e., the second portion of the release liner is separate from or can separate from the first portion of the release liner. In another aspect, the present teachings relate to a method of labeling a substrate, for example, a prescription drug container, using such a label laminate. In another aspect, the present teachings relate to a method for making the label laminates of the present teachings.

### TECHNICAL FIELD

The present teachings relate to labels and, more particularly, pharmacy labels. The present teachings also include methods of making and using such labels.

### BACKGROUND

Blank label forms having multiple detachable labels that individually can be applied to a substrate are desirable for many applications. One common use for blank label forms of this type is for labeling pharmacy prescription containers.

Pharmacy prescription container labels are an important part of a drug package, which contains essential information for a patient. The label usually includes a condensed version of the prescription drug information. It also contains information of the patient, the doctor who prescribes the drug, the pharmacy where the prescription is filled, the pharmacist who fills the prescription, and necessary cautionary information. For example, in Massachusetts, a prescription label that is affixed to the drug container must have the date of filling, the pharmacy name and address, the filing pharmacist's initials, the serial number of the prescription, the name of the patient, the name of the prescribing practitioner, the name of the prescription drug, directions for use and cautionary statement(s), and numbers of tablets or capsules in the container, if applicable. Because a prescription label contains information uniquely associated at least with the patient, the drug, the doctor, the pharmacy and the pharmacist, the label typically is printed at the point of filling the prescription and individually attached to the drug container. Moreover, because dispensed drugs vary as to the number and text of cautionary statements necessary on the container, appropriate warning labels also typically are printed and individually adhered to the container at the point of filling the prescription.

To provide accurate information, prevent mislabeling a drug container and save time in filling a prescription, pharmacy label forms that include the information of the prescription drug, patient, pharmacy, pharmacist, and warning statements have been developed. For example, Garrison in U.S. Pat. No. 5,328,208 discloses a pharmacy form that includes a number of labels releasably adhered to the form. After the pharmacy form is printed, a pharmacist peels off the main label from the form and applies it to the drug container, repeating this process for each additional warning label to be applied to the container. Although this design of pharmacy label form can provide the necessary information on a single form, because each of the main and warning labels is removed individually from the pharmacy label form and applied individually to the container, improvement in the efficiency of labeling a container with multiple labels was desired.

In another example, Foote et al. in U.S. Pat. No. 5,642,906 disclose a pharmacy label form that includes at least a main label portion and at least one smaller auxiliary label. A preferred blank includes a plurality of auxiliary labels. In use, at least one, but preferably not all, of the auxiliary labels on such a preferred blank are simultaneously removed from the backing sheet with the main label portion. Any auxiliary labels simultaneously removed with the main label but not printed upon are separated from the main label and discarded. However, with this design, after the main label and auxiliary labels are separated from the backing sheet, the blank unused auxiliary labels will be adhered to the pharmacist's hand and additional time is needed to dispose of, e.g., “flick away,” each of the blank unused auxiliary labels.

Accordingly, the art desires further improvement in the design of blank label forms containing multiple labels for printing on and application therefrom so that a user can more efficiently and easily label a substrate with multiple independent labels from a single label form.

### SUMMARY

The present teachings relate to labels and, more particularly, pharmacy labels for labeling a container such as a prescription drug container. In one aspect, the present teachings relate to a label laminate that includes a label sheet having a main label and one or more auxiliary labels releasably adhered to a second portion of a release liner, where the second portion of the release liner is separate or can separate from the first portion of the release liner. Such a design can permit the main and auxiliary labels readily to be removed and adhered to a substrate, for example, a container, while the unused auxiliary labels attached to the second portion of the release line easily can be discarded as “one-piece.”

In another aspect, the present teachings relate to a method of labeling a substrate, for example, a container, using such a label laminate. In particular embodiments, the methods relate to labeling a prescription drug container using a label laminate of the present teachings. In some embodiments, the method can include printing on the front side of the label sheet, for example, on the main label and one or more auxiliary labels, and the printing can take place at the point of sale such as at a pharmacy.

In another aspect, the present teachings relate to a method of making the label laminates of the present teachings. In particular embodiments, the methods relate to making a label laminate having a label sheet designed for printing prescription drug labels including appropriate information for that particular drug and end user so that the applicable legal requirements can be satisfied.

The foregoing, and other features and advantages of the present teachings, will be more fully understood from the following description, examples, and claims.

### BRIEF DESCRIPTION OF DRAWINGS

It should be understood that the drawings described below are for illustration purpose only. The drawings are not necessarily to scale and are not intended to limit the scope of the present teachings in any way.

FIG. 1A is a schematic of a front plan view of an embodiment of a label laminate including a label sheet and a release liner. (One or more separation lines 13 are drawn as dash lines to indicate that the separation line(s) are only associated with the release liner not the label sheet, and thus, are not visible in this view.)

FIG. 1B is a schematic of a back plan view of the embodiment of the label laminate shown in FIG. 1A. (The dashed line shows the outline of the label sheet, which is not visible in this view.)

FIG. 2 is a schematic of an enlarged not-to-scale cross-sectional view (cut along line 2-2) of the label laminate shown in FIG. 1A as viewed perpendicular to line 2-2.

FIG. 3 is a schematic of a front plan view of various embodiments of a label laminate where the one or more separation lines have different configurations.

FIG. 4 is a schematic of a front plan view of an embodiment of the label laminate of FIG. 1 after the main label and the one or more auxiliary labels are removed from the first portion of the release liner while remaining releasably adhered to the second portion of the release liner (shown as dashed lines because the second portion of the release liner in not visible in this view).

### DETAILED DESCRIPTION

Throughout the description, where compositions are described as having, including, or comprising specific components, or where processes are described as having, including, or comprising specific process steps, it is contemplated that compositions of the present teachings also consist essentially of, or consist of, the recited components, and that the processes of the present teachings also consist essentially of, or consist of, the recited process steps.

In the application, where an element or component is said to be included in and/or selected from a list of recited elements or components, it should be understood that the element or component can be any one of the recited elements or components and can be selected from a group consisting of two or more of the recited elements or components. It is anticipated that one or more members of a group can be included in, or deleted from, a group for reasons of convenience and/or patentability. For example, it should be understood that elements and/or features of a composition, an apparatus, or a method described herein can be combined in a variety of ways without departing from the spirit and scope of the present teachings, whether explicit or implicit herein. When any such inclusion or deletion occurs, the specification is herein deemed to contain the group as modified thus fulfilling the written description of all Markush groups used in the appended embodiments.

The use of the terms “include,” “includes,” “including,” “have,” “has,” and “having” should be understood generally as open-ended and non-limiting unless specifically stated otherwise. The use of any and all examples, or exemplary language (e.g., “such as”) provided herein is intended merely to better illuminate the invention and does not pose a limitation on the scope of the invention otherwise described or claimed. No language in the specification should be construed as indicating any non-claimed element essential to the practice of the invention.

The use of the singular herein includes the plural (and vice versa) unless specifically stated otherwise or clearly contradicted by the context. In addition, where the use of the term “about” is before a quantitative value, the present teachings also include the specific quantitative value itself, unless specifically stated otherwise.

It should be understood that the order of steps or order for performing certain actions is immaterial so long as the present teachings remain operable. Moreover, two or more steps or actions can be conducted simultaneously.

As used herein, the term “activation” or “activated” in connection with a thermally-activated substrate, a thermally-activated coating or a thermally-activated layer refers to color changes of the thermally-activated substrate, the thermally-activated coating or the thermally-activated layer. In some embodiments, when a thermally-activated substrate, a thermally-activated coating or a thermally-activated layer is exposed to heat, for example, in a controlled manner, the thermally-activated substrate, the thermally-activated coating and the thermally-activated layer can change from colorless to gray or black in the specific area of heat exposure. In certain embodiments, when the thermally-activated substrate, the thermally-activated coating or the thermally-activated layer is exposed to heat, the thermally-activated substrate, the thermally-activated coating and the thermally-activated layer can change from colorless to visible colors such as cyan, magenta, yellow, and combinations thereof.

One aspect of the present teachings relates to a label laminate. The label laminate generally includes a label sheet releasably adhered to a release liner, where the label sheet can include a main label and one or more auxiliary labels. The main label and each of the one or more auxiliary labels can include a front side having a printable surface and a back side having an adhesive. The release liner can include a first portion and a second portion, where the second portion of the release liner can be surrounded by or is defined by one or more separation lines to provide or allow separation of the second portion of the release liner from the first portion of the release liner. Accordingly, the main label and the one or more auxiliary labels can be removed from the first portion of the release liner while remaining releasably adhered to the second portion of the release liner. Such a design can have the main label and the one or more auxiliary labels overlapping at least portions of each of the first portion and the second portion of the release liner. Of course the label sheet can include other labels, for example, supplemental or secondary labels and unused space on the label sheet, all of which can be designed and configured in a variety of ways. The supplemental or secondary labels can be releasably adhered only to a first portion of the release liner or to the first and second portions of the release liner, for example, similar to the main and auxiliary labels.

A label sheet can be made from a flexible, conventional stock material typically used for the respective end use. In addition to paper and paper-like materials, the label sheet can be a plastic or other polymeric material, e.g., a biodegradable polymer, suitable for printing or displaying printed traces thereon. In certain embodiments, at least one layer of the label sheet or the label sheet itself can be a thermally-activated paper or other thermally-activated substrate.

A label laminate can be of standard paper size, for example, for printing on a retail or commercially available printer such as an ink-jet printer or a laser printer, or can be custom-sized to be compatible with any printer and/or print technique used to print on the label sheet. The label laminates also can be in the form of a roll such that multiple label sheets are present on one substantially continuous release liner, which can include perforations, die cuts or other separators to permit separation of individual label sheets (or individual label laminates, e.g., one label sheet per release liner), which can take the form of cut sheet label laminates such as cut sheet laser label laminates for use with a laser printer.

In some embodiments, the front side of the main label and each of the one or more auxiliary labels can include a printable surface or one or more printable layers, e.g., surfaces or layers that can receive and retain ink or “print” from a printer or be “activated” to display traces. In the latter case where activation is used to produce visible traces and indicia, the label sheet can be or include a thermally-activated substrate. In certain embodiments, the label sheet can include a thermally-activated substrate that takes the form of a thermally-activated coating or a thermally-activated layer, which can produce the visible images after activation. The various materials and techniques for providing a printable surface or printable layer are well known in the art including those for creating a thermally-activated printable surface or a thermally-activated printable layer.

The release liner can be made from a flexible, conventional stock material typically used for the respective end use. Exemplary release liners can be made from materials including, but not limited to, Fasson® 40# SCK and Fasson® 50# SCK and available from Fasson® Roll North America (Painesville, Ohio). Other release liners are available from other manufacturers including MACtac® (Stow, Ohio) and RICOH Electronics, Inc. (Duluth, Ga.). At least a portion of the release liner can be coated with a release material, e.g., a silicon-based coating. In certain embodiments, a first side of the release liner is coated with a silicon-based coating. In some embodiments, both the first side and a second side of the release liner can be coated with silicon-based coating. In particular embodiments, a single layer of silicon can be disposed on the first side of the release liner, which can be adjacent to the adhesive on the back side of the label sheet.

The back side of the main label and each of the one and more auxiliary labels can include an adhesive, for example, a pressure-sensitive adhesive. In some embodiments, as mentioned above, the release liner can include a release coating or a release material adjacent to the adhesive on the label sheet. The various materials and techniques for releasably adhering a label sheet to a release liner (or a label stock to a release sheet) are well known in the art.

In various embodiments, the main label can have two lengths and two widths where each of the lengths is longer than each of the widths. In some embodiments, at least one auxiliary label can extend in a direction that is parallel to the two lengths of the main label. In certain embodiments, each of the one or more auxiliary labels can extend in that direction. In some embodiments, at least one auxiliary label can extend in that direction that is parallel to the two widths of the main label. In certain embodiments, each of the one or more auxiliary labels can extend in that direction.

In various embodiments, each of the one or more auxiliary labels can have two lengths and two widths where each of the lengths is longer than each of the widths of the auxiliary label. In some embodiments, one or two lengths of at least one auxiliary label can be parallel to the two lengths of the main label. In particular embodiments, both lengths of each of the one or more auxiliary labels can be parallel to the two lengths of the main label. In some embodiments, one or two lengths of at least one auxiliary label can be parallel to the two widths of the main label. In particular embodiments, both lengths of each of the one or more auxiliary labels can be parallel to the two widths of the main label. In certain embodiments, the two lengths of at least one auxiliary label can be parallel to the two lengths of the main label while the two lengths of at least another one auxiliary label can be parallel to the two widths of the main label.

In some embodiments, the main label can be separate from an adjacent auxiliary label, for example, by a die cut. In certain embodiments, the main label can be separable from an adjacent auxiliary label, for example, by a perforation line. In some embodiments, an auxiliary label can be separate from an adjacent auxiliary label or adjacent auxiliary labels, for example, by a die cut. In certain embodiments, an auxiliary label can be separable from an adjacent auxiliary label, for example, by a perforation line. In various embodiments, a combination of die cuts and perforations can be present in a label sheet to separate the various labels, for example, a main label, auxiliary label(s), and any other labels or unused label sheet that may be present.

In various embodiments, a label sheet can be or include a thermally-activated substrate. For example, the label sheet can be or include a thermally-activated paper or a thermally-activated plastic substrate such as a sheet. In certain embodiments, the label sheet can include a thermally-activated coating or a thermally-activated layer. In some thermally-activated embodiments, the label sheet can withstand a temperature greater than about 1 00F without activation, or a temperature greater than about 150° F. without activation, or a temperature greater than about 200° F. without activation.

In particular embodiments, the front side of the label sheet can include one or more label coatings known in the art. For example, the one or more label coatings can protect the label sheet from environmental conditions (e.g., humidity, heat, cold, radiation, and/or abrasion) and/or can improve the making, printing, and/or using of the label laminate or label sheet. For example, the front side can include a heat-resistant coating and/or a moisture-resistant coating.

In various embodiments, one or more auxiliary labels can be color-coded. That is, each of the one or more auxiliary labels can have the same color different from the color of the main label, or each of the one or more auxiliary labels can have different colors. In some embodiments, the main label and/or one or more auxiliary labels can include pre-printed warning statements or other printed information or traces.

A release liner can include a first portion, a second portion, and one or more separation lines between the first portion and the second portion. The one or more separation lines can provide or permit separation of the second portion of the release liner from the first portion of the release liner. In some embodiments, the one or more separation lines can include at least one die cut. In certain embodiments, the one or more separation lines can include at least one perforation line. In some embodiments, the one or more separation lines can include at least one straight line. In certain embodiments, the one or more separation lines can include at least one curve. In particular embodiments, the second portion of the release liner can be partially or completely surrounded by the one or more separation lines. In the latter example, the one or more separation lines can define the second portion of the release liner.

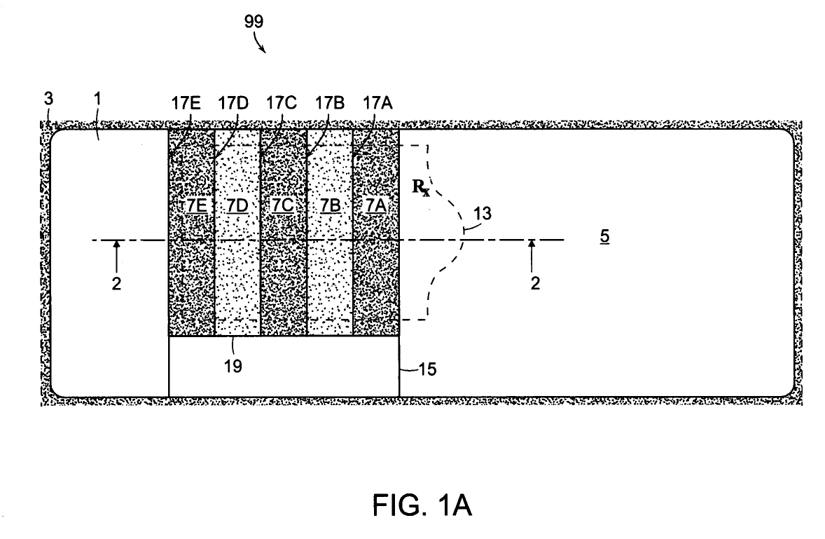

Turning to the pictured embodiment in FIG. 1A, the label laminate 99 in a front view includes a label sheet 1 adhered to a release liner 3, which can be seen in the front view of this embodiment. The label sheet 1 includes a main label 5 and several auxiliary labels 7A, 7B, 7C, 7D, and 7E. Each of lines 15, 17A, 17B, 17C, 17D, 17E, and 19, which are adjacent to one or more of the auxiliary labels, independently can be a die cut or a perforation line. A separation line 13 defining a second portion of the release liner 3 is shown with dashed lines because this portion of the release liner is not visible in this view.

As shown in FIG. 1B, which is the back view of the label laminate of FIG. 1A, the label laminate 99 on its back side has a release liner 3 that includes a first portion 9, a second portion 11, and at least one separation line 13. The separation line can provide or allow separation of the first portion of the release liner from the second portion of the release liner. The outline of the label sheet 1 is shown with dashed lines because the label sheet 1 is not visible in this view.

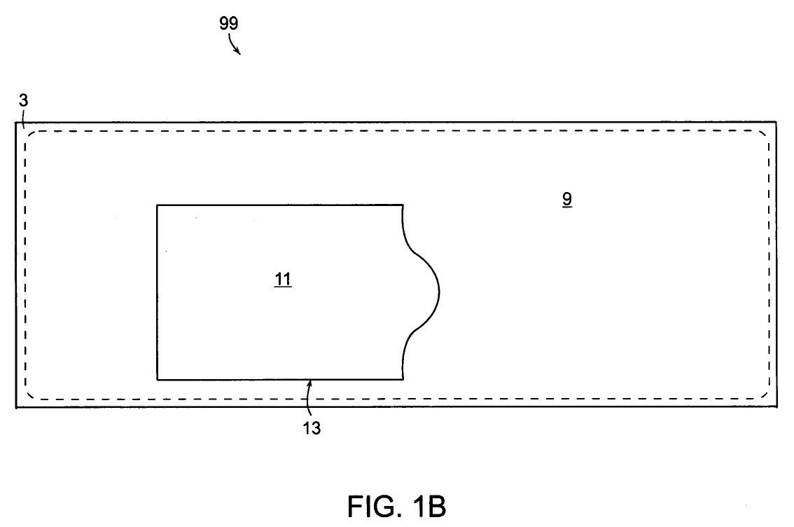

More specifically, as shown in FIG. 2, which is a cross-section of the label laminate 99 of FIG. 1A cut across line 2-2 and viewed perpendicular to line 2-2, each of lines 15, 17A, 17B, 17C, 17D, and 17E can extend completely through the label sheet to provide or allow separation of the main label and the auxiliary labels from their adjacent labels and the surrounding label sheet material. Further, the separation line 13 can extend completely through the release liner (but not the label sheet) to provide and permit separation of the first portion of the release liner 9 from the second portion of the release liner 11. It should be understood that the separation line or lines separating adjacent labels can be die-cuts, perforation lines, or combinations and variations thereof, depending on the particular end use.

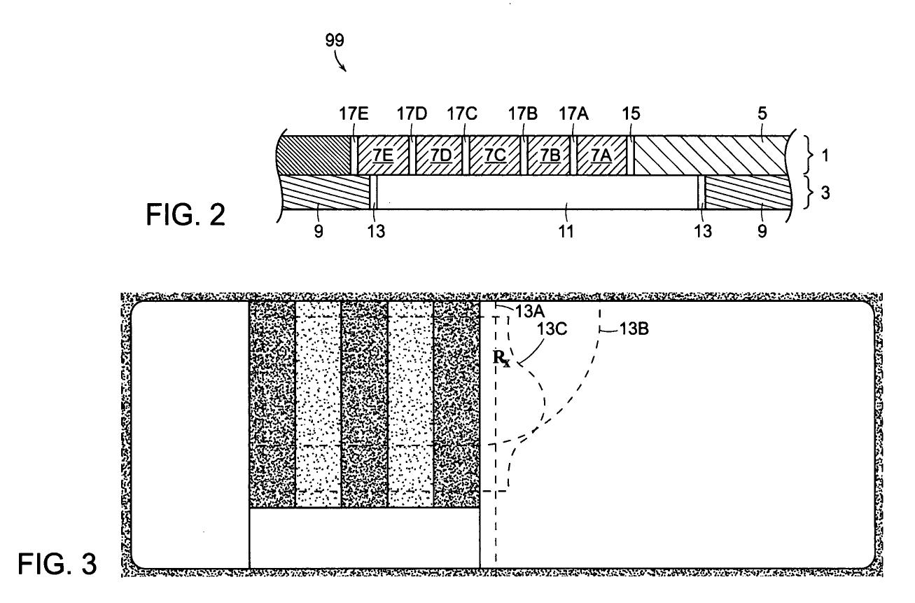

Various exemplary configurations of separations line(s) are shown in FIG. 3. The depicted separation line(s) include a straight line 13A running from one end or side of the release liner to the other end or side. In another embodiment, the second portion of the release liner is partially surrounded by the separation line(s) 13B. In yet another embodiment, the second portion of the release liner is surrounded or defined by the separation line(s) 13C.

Another aspect of the present teachings provides a method for labeling a substrate, for example, a container. The method generally includes removing a main label and one or more auxiliary labels from a first portion of a release liner while the main label and one or more auxiliary labels remains releasably adhered to a second portion of the release liner; removing at least one of the main label and the auxiliary labels from the second portion of the release liner; and attaching to a container at least one of the main label and the auxiliary labels.

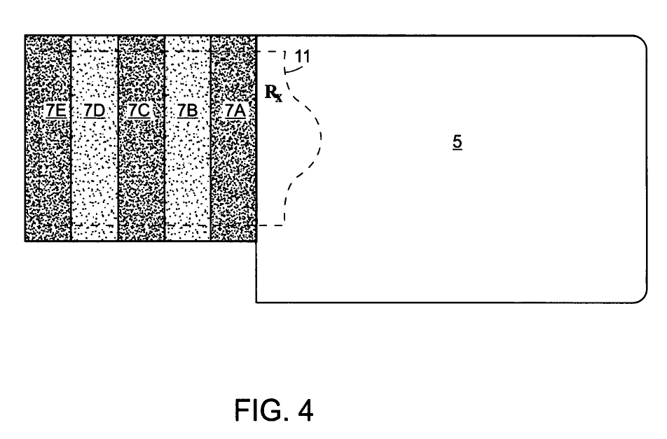

FIG. 4 shows a main label 5 and auxiliary labels 7A, 7B, 7C, 7D and 7E after removal from the first portion of a release liner. As can be seen in the figure, the main label and auxiliary labels remain detachably adhered to a second portion of the release liner 11 (shown with dashed line(s) because the second portion of the release liner is not visible in this view).

In various embodiments, a container to be labeled is used to dispense a drug to a patient, for example, a prescription drug container. Accordingly, in some embodiments, the method can include printing on the main label relevant information such as information of the drug, the patient, the doctor who prescribes the drug, the pharmacy where the drug is dispensed, the pharmacist who dispenses the drug, or combinations thereof. In some embodiments, the method can include printing information about the drug on one or more auxiliary labels. In certain embodiments, the information printed on the auxiliary labels can include cautionary or warning statements as well as any other symbols or depictions useful to convey a meaning to a viewer, for example, a patient. In various embodiments, the label sheet can include preprinted traces, for example, images, information or the like as described above, on its front side such as on the printable surface.

Another aspect of the present teachings provides a method for making a label laminate as described herein. The method can include providing a laminate roll, which can include a release sheet and a label stock releasably adhered to the release sheet (alternatively the label stock already can be cut into the label sheet(s) of the label laminate(s)); cutting the label stock to provide one or more label sheets, each of which can include a main label and one or more auxiliary labels; and cutting the release sheet to provide one or more release liners each of which can include a first portion and a second portion. In certain embodiments, the main label and the one or more auxiliary labels can be removable from the first portion of the release liner while remaining releasably adhered to the second portion of the release liner.

In practicing the methods of the present teachings, it should be understood that the order of cutting the label sheet and the release sheet to form a label laminate of the present teachings can be varied and involve multiple steps depending upon the design and dimensions of the final product and the apparatus used. For example, if a label laminate of the present teachings was made manually, the process would occur one cut at a time but the method and end result would be the same as if all of the cuts were made simultaneously.

It also should be understood that a “label stock” generally refers to a label sheet material or substrate in its raw, uncut form. For example, a label stock can be a label sheet material prior to it being cut into individual label sheets, with or without the cuts and perforations to provide a main label, auxiliary label(s) and any other labels or unused material. However, label stock also can refer to label sheet material that already is cut into the form of a label sheet, but without the cuts and perforations defining the main label, auxiliary label(s) and any other labels or unused material. Label stock typically is releasably adhered to a release sheet, which in combination can be in the form of a roll.

In addition, it should be understood that a “release sheet” generally refers to a release liner material or substrate in its raw, uncut form. For example, a release sheet can be the release liner material prior to it being cut into individual release liners and prior to cutting the release liner to provide a first portion and a second portion of the release liner. However, a release sheet can be cut to provide a first portion and a second portion of a release liner prior to the release sheet being cut into individual release sheets associated with one or more label sheets.

In some embodiments, the method can include providing a laminate roll including a release sheet and a label stock releasably adhered to the release sheet (alternatively the label stock already can be cut into the label sheet(s) of the label laminate(s)); cutting the label stock to provide one or more label sheets, each of which can include a main label and one or more auxiliary labels; and cutting the release sheet to provide one or more release liners each of which can include a first portion and a second portion, where the label stock includes a front side having a printable surface and a back side having an adhesive; cutting the label stock to provide one or more label sheets, each of the one or more label sheets including a main label and one or more auxiliary labels; and cutting the release sheet to provide one or more release liners, each of the one or more release liners including a first portion and a second portion, where the main label and the one or more auxiliary labels can be removable from the first portion while remaining releasably adhered to the second portion of the release liner.

In some embodiments, the method can include applying one or more label coatings to the front side of the label stock or the label sheet(s). For example, the one or more label coatings can protect the label stock or label sheets from environmental conditions (e.g., humidity, heat, cold, radiation, and/or abrasion) and/or can improve making, printing, and/or using the label laminates and label sheets. In certain embodiments, the method can include applying a heat-resistant coating to the front side of the label sheet. Of course the application of one or more coatings to the label stock or the label sheet necessarily can protect the main label and the auxiliary labels too.

In various embodiments, the label sheet can include a thermally-activated substrate or thermally-activated coating. For example, the label sheet can be or include a thermally-activated paper or a thermally-activated plastic sheet. In certain embodiments, the method can include applying a thermally-activated coating or thermally-activated layer onto the label sheet or onto a label coating or coatings adjacent to the label sheet. In some embodiments, the label sheet can withstand a temperature greater than about 100° F. without activation or a temperature greater than about 150° F. without activation. In certain embodiments, the label sheet can withstand a temperature greater than about 200° F. without activation.

In some embodiments, the method can include cutting the label sheet to provide one or more die cuts between the main label and an adjacent auxiliary label. In certain embodiments, the method can include cutting the label sheet to provide one or more die cuts between two adjacent auxiliary labels. In particular embodiments, the method can include cutting a label sheet to provide one or more die cuts to define the main label, one or more auxiliary labels, and any other labels and other material, for example, unused label sheet, that may define or form a label sheet. In some embodiments, the method can include cutting the label sheet to provide one or more perforation lines between the main label and an adjacent auxiliary label. In certain embodiments, the method can include cutting the label sheet to provide one or more perforation lines between two adjacent auxiliary labels. In particular embodiments, the method can include cutting a label sheet to provide one or more perforation lines to define the main label, one or more auxiliary labels, and any other labels and other material, for example, unused label sheet, that may define or form a label sheet. The methods also can include combinations of any of the above, for example, cutting to provide perforation lines and die cuts.

In some embodiments, the method can include cutting the release sheet to provide one or more die cuts to provide separation between the first portion and the second portion of the release liner. In certain embodiments, the method can include making one die cut to provide separation between the first portion and the second portion of the release liner. In some embodiments, the method can include cutting the release sheet to provide one or more perforation lines to allow separation between the first portion and the second portion of the release liner. In certain embodiments, the method can include making one perforation line to allow separation between the first portion and the second portion of the release liner. The methods also can include combinations of any of the above, for example, cutting to provide perforation lines and die cuts.

In particular embodiments, the method can include dividing a laminate roll into small rolls, each of which can include one or more label laminates as defined herein. The small rolls of label laminates can be sized and dimensioned to be compatible with commercially available printers including thermal printers such as direct thermal printers. Further, the method can include cutting the laminate roll or small rolls of label laminates to form a label laminate sheet suitable for passing through a printer, for example, a laser or ink-jet printer at a retail store or a pharmacy. In certain embodiments, multiple label sheets, for example, main labels and corresponding auxiliary labels, can be present on one release liner, for example, in the form of a sheet. In certain embodiments, the label sheets can be present on a sheet-sized release liner in an array, for example, in a 2×1 array, a 1×2 array, a 2×2 array, a 2×3 array, a 3×2 array, a 3×3 array, a 3×1 array, a 1×3 array, a 4×4 array, and so on.

Certain embodiments of the invention are described herein, including the best mode known to the inventors for carrying out the invention. Variations of these embodiments will become apparent to those of ordinary skill in the art upon reading the foregoing description. The inventor expects skilled artisans to employ such variations as appropriate, and the inventor intends for the invention to be practiced otherwise than specifically described herein. Accordingly, the invention includes all modifications and equivalents of the subject matter recited in the embodiments appended hereto as permitted by applicable law. Moreover, any combination of the above-described elements in all possible variations thereof is encompassed by the invention unless otherwise indicated herein or otherwise clearly contradicted by context. Further, the scope of the present invention is to be defined not by the preceding illustrative description, or modifications and equivalents thereof but instead by the following claims, and all changes that come within the meaning and range of equivalency of the claims are intended to be embraced therein.

1. A label laminate comprising:
a label sheet releasably adhered to a release liner, wherein:
the label sheet comprises a main label and one or more auxiliary labels, wherein the main label and each of the one or more auxiliary labels comprise a front side comprising a printable surface and a back side comprising an adhesive;
the release liner comprises a first portion and a second portion, wherein the second portion of the release liner is surrounded by one or more separation lines to provide or allow separation of the second portion from the first portion of the release liner; and
the main label and the one or more auxiliary labels are removable from the first portion of the release liner while remaining releasably adhered to the second portion of the release liner.

2. The label laminate of claim 1, wherein the one or more separation lines comprise at least one die cut.

3. The label laminate of claim 1, wherein the one or more separation lines comprise at least one perforation line.

4. (canceled)

5. (canceled)

6. (canceled)

7. (canceled)

8. (canceled)

9. The label laminate of claim 1, wherein the main label is separate from an adjacent auxiliary label by a die cut.

10. The label laminate of claim 1, wherein the main label is separable from an adjacent auxiliary label by a perforation line.

11. The label laminate of claim 1, wherein the label sheet comprises a thermally-activated coating.

12. The label laminate of claim 1, wherein the front side of the label sheet comprises a heat-resistant coating.

13. The label laminate of claim 1, wherein the label laminate is in the form of a sheet.

14. The label laminate of claim 13, wherein the sheet comprises more than one label sheet.

15. The label laminate of claim 1, wherein the label laminate comprises more than one label sheet on the release liner

16. The label laminate of claim 15, wherein the label laminate is in the form of a roll.

17. The label laminate of claim 16, wherein die cuts, perforations or a combination thereof are present between adjacent label sheets.

18. A method for labeling a container, the method comprising:
providing the label laminate of claim 1;
removing the main label and one or more auxiliary labels from the first portion of the release liner;
removing the main label and optionally one or more auxiliary labels from the second portion of the release liner; and
attaching to a container the main label and optionally the one or more auxiliary labels that are removed from the second portion of the release liner.

19. (canceled)

20. The method of claim 18, wherein the container is useful in dispensing a drug to a patient.

21. The method of claim 20 comprising printing information of the drug and the patient on the main label.

22. The method of claim 21 comprising printing information of the drug on one or more auxiliary labels.

23. A method for making label laminates, the method comprising:
providing a laminate roll comprising a release sheet and a label stock releasably adhered to the release sheet, wherein the label stock comprises a front side comprising a printable surface and a back side comprising an adhesive;
cutting the label stock to provide one or more label sheets, each of the one or more label sheets comprising a main label and one or more auxiliary labels; and
cutting the release sheet to provide one or more release liners, each of the one or more release liners corresponding to at least one label sheet and comprising a first portion and a second portion,
wherein the main label and the one or more auxiliary labels are removable from the first portion of the release liner while remaining releasably adhered to the second portion of the release liner.

24. (canceled)

25. (canceled)

26. The method of claim 23 comprising cutting the one or more label sheets to provide one or more die cuts between the main label and an adjacent auxiliary label and optionally between two adjacent auxiliary labels.

27. (canceled)

28. The method of claim 23 comprising cutting the release sheet to provide one or more die cuts to provide separation between the first portion and the second portion of the release liner.

29. (canceled)

30. The method of claim 23, wherein providing a laminate roll comprises providing a laminate roll comprising a release sheet and a label stock comprising label sheets, and cutting the label stock comprises cutting the label sheets to provide a main label and one or more auxiliary labels.
